(19) United States
(12) Patent Application Publication
(10) Pub. No.: US 2010/0017863 A1
(43) Pub. Date: Jan. 21, 2010

(54) PORTABLE STORAGE APPARATUS FOR PROVIDING WORKING ENVIRONMENT MIGRATION SERVICE AND METHOD THEREOF

(76) Inventors: Moonyoung Chung, Daejon (KR); Kyong-I Ku, Gyeonggi-do (JP); Won-Young Kim, Daejon (JP); Wan Choi, Daejon (JP)

Correspondence Address: AMPACC Law Group, 3500 188th Street S.W., SUITE 103, Lynnwood, WA, 98037, US

(21) Appl. No.: 12/517,549

(22) PCT Filed: Nov. 30, 2007
(86) PCT No.: PCT/KR07/06158

§ 371 Date: Jun. 3, 2009

(30) Foreign Application Priority Data
Dec. 4, 2006 (KR) 10-2006-0121366
Oct. 5, 2007 (KR) 10-2007-0100559

(51) Int. Cl. G06F 12/00; H04L 9/32; G06F 21/00; G06F 15/16

(52) U.S. Cl. 726/7; 711/154; 709/231; 711/E12.001

(57) ABSTRACT

Provided are an apparatus and method for providing a working environment migration service. The portable storage apparatus, includes: a management and execution unit for performing user authentication by connection to an external user terminal, managing a user profile and application information, and executing a context management unit; a working environment storage unit for storing an application context and data representing the working state at the time of log out; and the context management unit for recovering and executing the application context and data stored in the working environment storage unit upon execution by the management and execution unit, and collecting the application context and data representing the working state at the time of log out, and storing them in the working environment storage unit.

### TECHNICAL FIELD

The present invention relates to an apparatus for providing a working environment migration service and a method thereof; and more particularly, to a portable storage apparatus for providing a working environment migration service, which selectively collects and stores the context of an application being executed in a terminal, recovers the stored application context upon user's restart of work and provides a previous working environment as it is, to thereby allow the user to continuously perform the work more conveniently, a method thereof and a computer-readable recording medium for recording a software program for realizing the method.

This work was supported by the IT R&D program for MIC/IITA [2005-S-007-02, “A Development of Open Software Based On-Demand Officeware Deployment Technologies”].

The application used herein means application software that is designed for a user terminal to support a specific work such as a document editor, a presentation application, a spread sheet, a web browser, and a media player.

Further, the application context used herein denotes the operation state of application, working data, a working document file, a working page position, the sequence and position of working application on a screen, a page being browsed in a web browser and its position, favorites, a list of addresses browsed, a music file being executed in a media player and a list thereof, which are working state information of the application.

### BACKGROUND ART

Conventionally, when a working environment migrates from one terminal to another in case of using several terminals by a user, the user first stores data being used in a working application in a terminal or a portable storage apparatus connected to a network. Next, the user executes an application to execute the data stored in the terminal connected to the network before opening the data and restarting a work, or connects the portable storage apparatus to a terminal that will start a work and executes an application to execute the data stored in the portable storage apparatus before opening the data and restarting the work.

In the above-described working environment migration method using the network terminal or portable storage apparatus, the user has to directly store data and to find data to be executed and then execute the data one by one, which causes an inconvenience.

In addition, such conventional methods for storing and recovering the application context are greatly classified into two: a method for storing the application context in a terminal and a method for storing the application context in a server. The method for storing application context in a terminal has a difficulty of securing the continuity of user's existing work in another terminal, and the method for storing the application context in a server has a difficulty of guaranteeing the continuity of working under the situation that no network is connected thereto.

### DISCLOSURE OF INVENTION

### Technical Problem

It is, therefore, an object of the present invention to solve the problem that cannot guarantee the continuity of work due to different environments of user terminals and the trouble in network connection.

More specifically, the present invention is to provide a portable storage apparatus for providing a working environment migration service, which selectively collects and stores the context of an application being executed in a terminal, recovers the stored application context upon user's restart of work and provides a previous working environment as it is, to thereby allow the user to continuously perform the work more conveniently, a method thereof and a computer-readable recording medium for recording a software program for realizing the method.

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

### Technical Solution

In accordance with an aspect of the present invention, there is provided a portable storage apparatus, including: a management and execution unit for performing user authentication by connection to an external user terminal, managing a user profile and application information, and executing a context management unit; a working environment storage unit for storing an application context and data representing the working state at the time of log out; and the context management unit for recovering and executing the application context and data stored in the working environment storage unit upon execution by the management and execution unit, and collecting the application context and data representing the working state at the time of log out, and storing them in the working environment storage unit.

In accordance with another aspect of the present invention, there is provided a method for providing a working environment migration service, including the steps of: receiving a user profile set up by a user terminal and managing the user profile; performing user authentication by connection to the user terminal; acquiring a profile of the user terminal; recovering and executing pre-stored application context and data; and collecting and storing an application context and data representing the current working state at the time of log out.

In accordance with another aspect of the present invention, there is provided a computer-readable recording medium that records a software program for realizing the following functions in a portable storage apparatus having a processor, the program including the steps of: receiving a user profile set up by a user terminal and managing the user profile; performing user authentication by connection to the user terminal; acquiring a profile of the user terminal; recovering and executing pre-stored application context and data; and collecting and storing an application context and data representing the current working state at the time of log out.

### Advantageous Effects

As mentioned above and will be set forth below, the present invention can execute works stored in any terminals since it collects application information and document information a user is working on and stores them in a portable storage apparatus.

In addition, the present invention can reduce a user's working time since it does not need to again execute an application a user was working on by again executing a previous working environment as it is simultaneously with connection to a terminal.

Moreover, the present invention can provide convenience to a user and also save time for separate installation since it does not require a separate installation although the user performs works in any terminals by receiving a software service through a streaming service.

### BRIEF DESCRIPTION OF THE DRAWINGS

FIG. 1 is a view illustrating a configuration of an overall system for providing a working environment migration service to which the present invention is applied.

FIG. 2 is a view illustrating an internal configuration of a portable storage apparatus for providing a working environment migration service in accordance with an embodiment of the present invention and a user terminal connected thereto.

FIG. 3 is a flowchart describing a method for storing working environments in accordance with an embodiment of the present invention.

FIG. 4 is a flowchart describing a method for executing a work in accordance with an embodiment of the present invention.

FIG. 5 is a view showing an appearance where working environments migrate in accordance with an embodiment of the present invention.

### BEST MODE FOR CARRYING OUT THE INVENTION

The advantages, features and aspects of the invention will become apparent from the following description of the embodiments with reference to the accompanying drawings, which is set forth hereinafter, and thus, the present invention will easily be carried out by those skilled in the art. Further, in the following description, well-known arts will not be described in detail if it seems that they could obscure the invention in unnecessary detail. Hereinafter, preferred embodiments of the present invention will be described in detail with reference to the accompanying drawings.

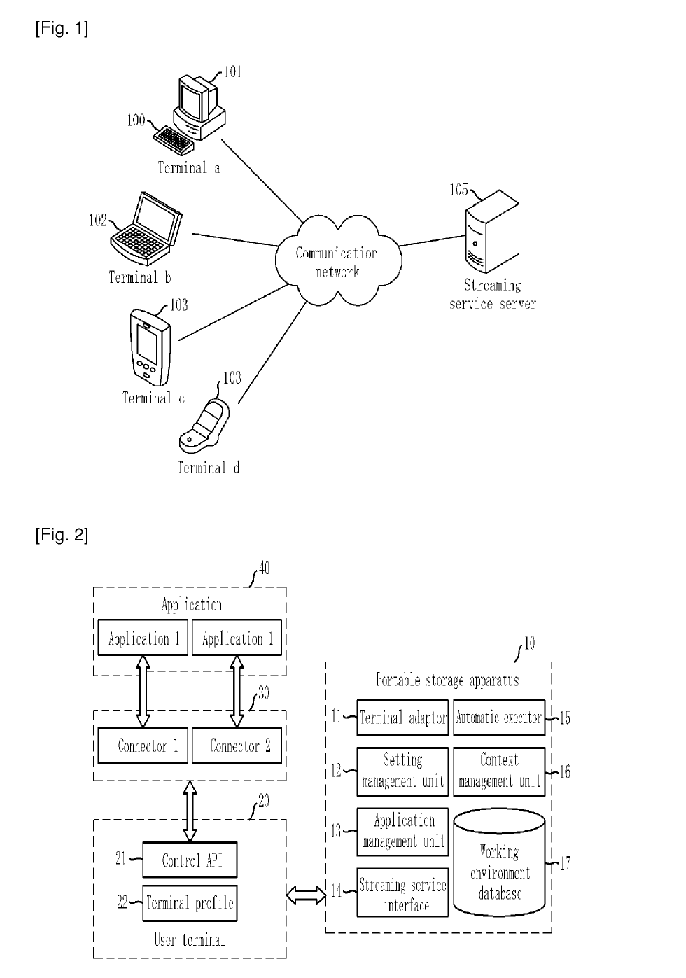

FIG. 1 is a view illustrating a configuration of an overall system for providing a working environment migration service to which the present invention is applied.

Referring to FIG. 1, the system for providing a working environment migration service to which the present invention is applied includes a portable storage apparatus 100 for storing a working environment a user is working on in user terminals 101 to 104 and migrating the stored working environment, the user terminals 101 to 104 that support wireless or wired network communications, and a streaming service server 105 for providing an application streaming service, e.g., a software service.

To be more specific, the user terminals 101 to 104 connected to a communication network are able to use the software service by connection to the streaming service server 105, but any of them not connected thereto cannot do that. However, the use of the software service is limited only to a case where an application to execute data stored in the portable storage apparatus 100 does not exist in the corresponding user terminal. Thus, in case where an application to execute data stored in the portable storage apparatus 100 exists in the corresponding user terminal, even the user terminals not connected to the network can use a working environment migration service.

At this time, the user terminals denote all terminals mounted with a Central Processing Unit (CPU) and an Operating System (OS), such as a Personal Computer (PC), a laptop computer, a Personal Digital Assistants (PDA), a smart phone, and a Portable Multimedia Player (PMP).

FIG. 2 is a view illustrating an internal configuration of a portable storage apparatus for working environment migration service in accordance with an embodiment of the present invention and a user terminal connected thereto.

Referring to FIG. 2, the portable storage apparatus 10 for working environment migration service in accordance with an embodiment of the present invention, which is called the portable storage apparatus hereinafter, includes a terminal adaptor 11, a setting management unit 12, an application management unit 13, a streaming service interface 14, an automatic executor 15, a context management unit 16, and a working environment database 17.

The terminal adaptor 11 serves to acquire information of a user terminal 20 by contact therewith, and perform a proper connection thereto based on the acquired information of the user terminal 20.

The information of the user terminal 20 may be the type and interface information of the user terminal 20.

The setting management unit 12 receives and manages a user profile established by a user and provided from the user terminal 20 connected through the terminal adaptor 11.

At this time, the user profile includes information on a user, e.g., user ID and password, information set up by the user, i.e., context and data information, on an application to be collected and stored, and information required for using a streaming service, e.g., an application address, and whether to use a streaming service.

The application management unit 13 manages information on an application capable of executing an application context and data stored in the working environment database 17.

The streaming service interface 14 determines whether or not there is an application capable of executing an application context and data stored in the working environment database 17 in the user terminal 20. If there is no application capable of executing an application context and data stored in the working environment database 17 in the user terminal 20, the interface 14 receives a streaming service, i.e., software service by connection to the streaming service server based on the user profile, particularly, a user ID, a user password, and an address of application on the streaming service server, managed by the setting management unit 12.

The automatic executor 15 performs user authentication based on user login information provided from the user terminal 20 connected through the terminal adaptor 11, and automatically executes the context management unit 16.

When the context management unit 16 is automatically executed by the automatic executor 15, it recovers and executes the application context and data, i.e., the state of working having previously been executed in the user terminal 20, pre-stored in the working environment database 17. And then, it collects the user's working state, i.e., the application context and data depending on the user profile, particularly, context and data information on an application to be collected and stored, managed by the setting management unit 12 when the user logs out the working environment migration service after completion of working, and stores them in the working environment database 17.

The user terminal 20 connected to the portable storage apparatus 10 executes an application 40 through a connector 30.

The user terminal 20 is provided with a control Application Programming Interface (API) 21 which is an API to control an application, e.g., software, and a terminal profile 22 for providing the portable storage apparatus 10 with information on the user terminal 20 such as application information installed in the terminal.

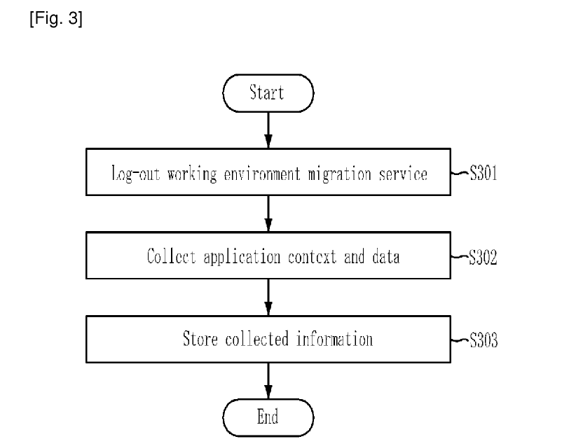

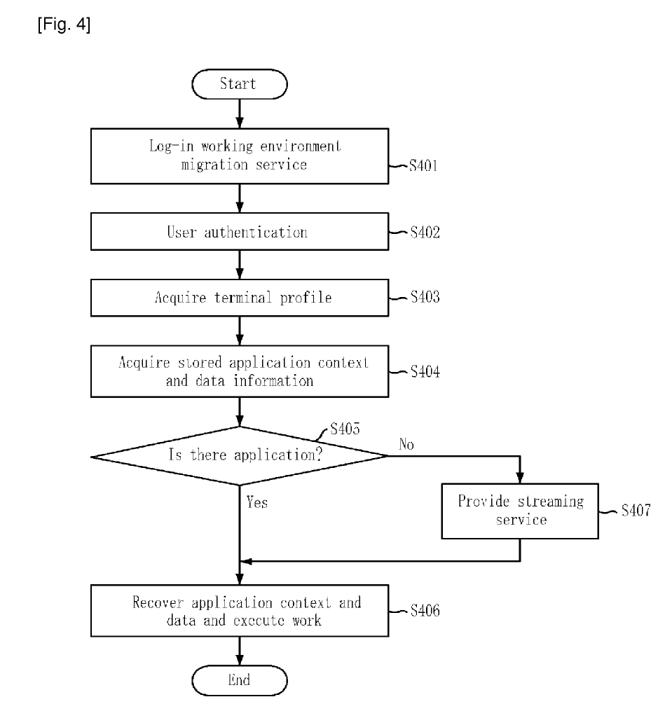

Now, a process of executing a working environment migration service by the portable storage apparatus 10 operating as above will be described in more detail with reference to FIGS. 3 and 4.

FIG. 3 is a flowchart describing a method for storing working environments in accordance with an embodiment of the present invention.

To start with, when a user finishes a work on the user terminal and logs out a working environment migration service in step S301, the portable storage apparatus 10 collects a user's working state, i.e., application context and data based on a user profile in step S302.

Next, the portable storage apparatus 10 stores the collected application context and data in step S303.

FIG. 4 is a flowchart describing a method for executing a work in accordance with an embodiment of the present invention.

First of all, the portable storage apparatus 10, upon connection to the user terminal 20, receives login information from the user and automatically executes a working environment migration service in step S401.

Next, the portable storage apparatus 10 executes user authentication based on the received user login information in step S402.

Thereafter, the portable storage apparatus 10 acquires user terminal information, i.e., the terminal profile 22, from the user terminal 20 in step S403, and acquires stored application context and data information, i.e., information on the state of work having previously been executed in the user terminal 20, in step S404.

In succession, the portable storage apparatus 10 determines whether or not there is an application to execute the acquired application context and data in the user terminal 20 in step S405.

At this time, the portable storage apparatus 10 can determine whether or not there is a corresponding application installed in the user terminal 20 based on the acquired user terminal information, i.e., the terminal profile 22.

As a result of the determination in step S405, if there is any application to execute a work in the user terminal 20, the portable storage apparatus 10 recovers the acquired context and data and executes this in step S406.

At this time, the portable storage apparatus 10 recovers the application context and data by setting recovery setting values different from each other depending on the type of the user terminal 20 connected thereto and interface information.

Meanwhile, as a result of the determination in step S405, if there is no application to execute a work in the user terminal 20, the portable storage apparatus 10 receives a required application service, e.g., a software service, by connection to a streaming service server in step S407, and recovers the acquired application context and data and executes this in step S406.

At this time, the user terminal 20 is designed to support a network communication so as to receive a required software service.

As described above, the portable storage apparatus 10 is able to execute a working environment migration service suitably for the purpose thereof depending on the type of the user terminal 20.

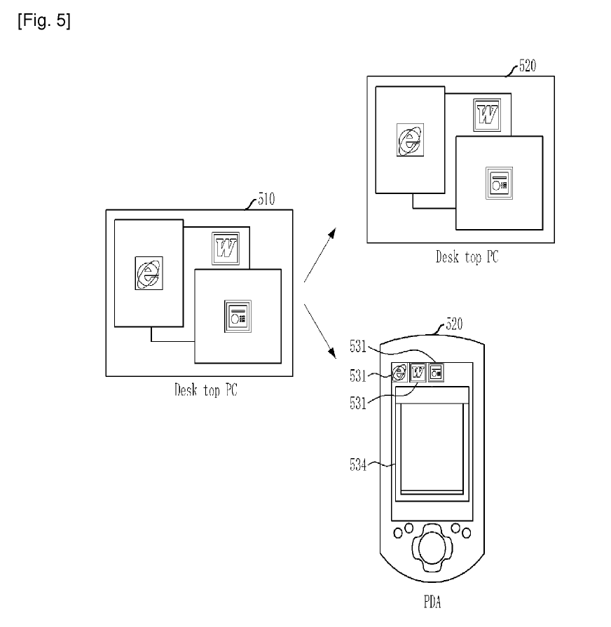

FIG. 5 is a view showing an appearance where working environments migrate in accordance with an embodiment of the present invention.

Referring to FIG. 5, when a working environment migrates from a working terminal 510 to any of other terminals 520 and 530, if a terminal to be executed is the terminal 520 having the same environment as the working terminal 510, the portable storage apparatus executes the work of the terminal 520 in the same manner as in the working terminal 510, and if a terminal to be executed is the terminal 530 having a different environment from the working terminal 520, it executes the work of the terminal 530 in a manner suitable for the type of the terminal 530, i.e., depending on the profile of the terminal.

As one example, in case where a working environment migrates from the desk top PC 510 to another desk top PC 520, the portable storage apparatus may represent the working environment of the desk top PC 510 in the desk top PC 520 as it is, while in case where a working environment migrates from the desk top PC 510 to the PDA 530, the portable storage apparatus may represent applications the user is working on as icons 531 to 533 and represent only an application 534 selected by the user as the whole screen.

At this time, if the screen resolution of the terminal where the working environment is to be migrated is not the same as that of the working terminal, the portable storage apparatus recovers the application context and data by using a repurposing technique.

For example, when the working environment of the desk top PC 510 migrates to a terminal with a very small screen size like the PDA 530, the portable storage apparatus may recover the application context and data by another method that employs a repurposing technique depending on the profile of the PDA 530.

In accordance with the above-mentioned present invention, it is possible to realize the functions of collecting and storing data and application state information, of recovering the application state information, and of dynamically linking application control library for execution, upon request of the user.

Further, the present invention provides a portable storage apparatus mounted with a database system storing a program of collecting application context and data on a screen and a method therefor, including a repurposing method and system that support various terminals and an interface for a streaming server that support terminals on which no application is installed and a method therefor.

The method of the present invention set forth above may be implemented by a computer program. The codes and code segments constituting the program can be deduced by a computer programmer skilled in the art. Also, the program is stored in a computer-readable recording medium or information storage medium, and can be read and executed by the computer, thereby implementing the method of the present invention. The recording medium includes all types of recoding media readable by the computer.

The present application contains subject matter related to Korean Patent Application Nos. 2006-0121366 and 2007-0100559, filed in the Korean Intellectual Property Office on Dec. 4, 2006 and Oct. 5, 2007, respectively, the entire contents of which are incorporated herein by reference.

While the present invention has been described with respect to the particular embodiments, it will be apparent to those skilled in the art that various changes and modifications may be made without departing from the spirit and scope of the invention as defined in the following claims.

1. A portable storage apparatus, comprising:
a management and execution unit for performing user authentication by connection to an external user terminal, managing a user profile and application information, and executing a context management unit;
a working environment storage unit for storing an application context and data representing the working state at the time of log out; and
the context management unit for recovering and executing the application context and data stored in the working environment storage unit upon execution by the management and execution unit, and collecting the application context and data representing the working state at the time of log out, and storing them in the working environment storage unit.

2. The portable storage apparatus of claim 1, wherein the management and execution unit includes:
a terminal adaptor for performing a connection to the user terminal;
an automatic executor for executing user authentication upon connection to the user terminal through the terminal adaptor and automatically executing the context management unit;
a setting management unit for receiving a user profile set up by the user terminal connected through the terminal adaptor and managing the user profile; and
an application management unit for managing information on an application to execute the application context and data stored in the working environment storage unit.

3. The portable storage apparatus of claim 1, further comprising:
a streaming service support unit for receiving a streaming service by connection to an external streaming service server when there is no application to execute a work in the user terminal.

4. The portable storage apparatus of claim 3, wherein the application context and data pre-stored in the working environment storage unit are an application context and data having previously been executed in the user terminal.

5. The portable storage apparatus of claim 3, wherein the user profile includes at lest one of a user ID, a user password, context and data information on an application to be collected and stored, and information required for using a stream service.

6. The portable storage apparatus of claim 5, wherein the information required for using a stream service includes a user ID and a user password required for connection to the streaming service server, and address information of an application on the streaming service server.

7. A method for providing a working environment migration service, comprising the steps of:
receiving a user profile set up by a user terminal and managing the user profile;
performing user authentication by connection to the user terminal;
acquiring a profile of the user terminal;
recovering and executing pre-stored application context and data; and
collecting and storing an application context and data representing the current working state at the time of log out.

8. The method of claim 7, further comprising the step of:
receiving a required application service by connection to an external streaming service server when there is no application to execute the pre-stored application context and data in the user terminal.

9. The method of claim 8, wherein the user profile includes at lest one of a user ID, a user password, context and data information on an application to be collected and stored, and information required for using a stream service.

10. The method of claim 9, wherein the information required for using a stream service includes a user ID and a user password required for connection to the streaming service server, and address information of an application on the streaming service server.

11. The method of claim 7, wherein the pre-stored application context and data are an application context and data having previously been executed in the user terminal.

12. A computer-readable recording medium that records a software program for realizing the following functions in a portable storage apparatus having a processor, the program comprising the steps of:
receiving a user profile set up by a user terminal and managing the user profile;
performing user authentication by connection to the user terminal;
acquiring a profile of the user terminal;
recovering and executing pre-stored application context and data; and
collecting and storing an application context and data representing the current
working state at the time of log out.

13. The computer-readable medium of claim 12, wherein the program further comprising the step of:
receiving a required application service by connection to an external streaming service server when there is no application to execute the pre-stored application context and data in the user terminal.
